(19) United States
(12) Patent Application Publication
(10) Pub. No.: US 2026/0352741 A1
(43) Pub. Date: Nov. 5, 2026

(54) OPPORTUNISTIC TRANSCODING

(71) Applicant: Snap Inc., Santa Monica, CA (US)

(72) Inventors: Quanzhao He, Los Angeles, CA (US); Bradley Volen, Simi Valley, CA (US)

(21) Appl. No.: 19/213,789

(22) Filed: May 20, 2025

Related U.S. Application Data
(60) Provisional application No. 63/800,279, filed on May 5, 2025.

(51) Int. Cl. H04L 67/5651; H04L 43/0811; H04L 67/1074; H04L 67/5682

(52) U.S. Cl. CPC H04L 67/5651; H04L 43/0811; H04L 67/1085; H04L 67/5682

(57) ABSTRACT

A machine performs or causes a device to perform a first phase test that checks readiness of the device for transcoding a media file that is stored by a server. The first phase test includes a storage check for contemporaneous storage of the media file by both the server and the device. Based on successful completion of the first phase test, the machine performs or causes the device to perform a second phase test that checks the media file itself. The media suitability test includes a comparison of a current file size of the media file to a predicted file size of the media file if it were to be transcoded. Based on successful completion of the media suitability test, the machine initiates or causes the device to initiate a transcoding of the media file.

### CLAIM OF PRIORITY

This application claims the benefit of priority to U.S. Provisional Application Serial No. 63/800,279, filed on May 5, 2025, which is incorporated herein by reference in its entirety.

### TECHNICAL FIELD

The subject matter disclosed herein generally relates to the technical field of special-purpose machines that facilitate transcoding of media files, including software-configured computerized variants of such special-purpose machines and improvements to such variants, and to the technologies by which such special-purpose machines become improved compared to other special-purpose machines that facilitate transcoding of media files. Specifically, the present disclosure addresses systems and methods to facilitate opportunistic transcoding of one or more media files.

### BACKGROUND

Cloud storage costs for media files are directly influenced by the size (e.g., file size) of the media files, as larger files require more storage capacity and incur higher ongoing expenses. Compression codecs for media files are continually evolving to achieve greater compression ratios, reducing file sizes while maintaining acceptable quality, which can significantly lower storage costs. However, older media files typically remain stored in their original format, compressed with older and less efficient codecs, and incurring potentially unnecessary storage costs on an ongoing basis, which may result in missed opportunities for cost savings and storage optimization.

### BRIEF DESCRIPTION OF THE DRAWINGS

Some variants are illustrated by way of example and not limitation in the figures of the accompanying drawings.

FIG. 1 is a network diagram illustrating a network environment suitable for opportunistic transcoding, according to some examples.

FIG. 2 is a block diagram illustrating components of a controller machine suitable for opportunistic transcoding, according to some examples.

FIG. 3 is a block diagram illustrating components of a device suitable for opportunistic transcoding, according to some examples.

FIGS. 4-6 are flowcharts illustrating operations of a device in performing a method of opportunistic transcoding, according to some examples.

FIG. 7 is a block diagram illustrating components of a machine, according to some examples, able to read instructions from a machine-readable medium and perform any one or more of the methodologies discussed herein.

### DETAILED DESCRIPTION

Example methods (e.g., algorithms) facilitate opportunistic transcoding of one or more media files, and example systems (e.g., special-purpose machines configured by special-purpose software) are configured to facilitate opportunistic transcoding of one or more media files. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided. In the following description, for purposes of explanation, numerous specific details are set forth to provide a thorough understanding of various examples. It will be evident to one skilled in the art, however, that the present subject matter may be practiced without these specific details.

Even though it may be beneficial to transcode many media files that reside in cloud storage, and thus reduce their file sizes and consequent storage costs, a systematic rote approach may be cost-inefficient. Downloads from clouds and uploads to clouds typically incur costs. Certain media files may be unsuitable for transcoding (e.g., from a current compression format to a new one), such as where the reduction in file size would be minimal. The device to perform the transcoding may be unsuitable, temporarily or permanently, such as where its battery level or available memory would be insufficient. However, in situations where a device has already downloaded a media file, its download cost has already been incurred. The systems and methods discussed herein are accordingly configured to evaluate such situations as opportunities for transcoding a media file stored concurrently by the device and by cloud storage, determine whether a transcoding of the media file by the device is to be initiated, and if yes, to initiate the transcoding of the media file by the device.

In various examples, a machine (e.g., a controller machine or a device) performs or causes a device to perform a device readiness test (e.g., as a first phase check) that checks readiness of the device for transcoding (e.g., re-transcoding) a media file that is stored by a server machine, at least. The device readiness test includes a storage check for contemporaneous storage of the media file by both the server machine and the device, indicating that the device has already downloaded the media file from the server machine (e.g., and incurred costs of such a download) or at least has no current need to download the media file from the server machine.

Based (e.g., exclusively) on successful completion (e.g., passing) of the device readiness test, the machine performs or causes the device to perform a media suitability test (e.g., as a second phase check) that checks the media file that is stored by the device. The media suitability test is based on (e.g., includes) a comparison of a current file size of the media file as stored by the server machine (e.g., and also as contemporaneously stored by the device) to a predicted file size of the media file if it were to be transcoded from a current compression level (e.g., via a current compression codec) of the media file to a transcoded compression level (e.g., via an alternative compression codec) of the media file. In some examples, this comparison is based on a predetermined minimum threshold for file size reduction.

Based (e.g., exclusively) on successful completion of the media suitability test, the machine initiates or causes the device to initiate a transcoding of the media file from the current compression level to the transcoded compression level (e.g., via the alternative compression codec) by the device, which stores the media file contemporaneously with the server machine.

The systems and methods discussed herein accordingly provide specific technical improvements over conventional transcoding systems and methods, such as a two–phase test that first checks for device readiness and then checks for media file suitability. In contrast with simply transcoding media files based on predetermined rules the systems and methods discussed herein perform targeted technical evaluations of both device capabilities and media characteristics to identify favorable (e.g., optimal) transcoding opportunities. These technical improvements enable more efficient resource utilization while solving the specific technical problem of reducing cloud storage costs through selective media optimization.

The term “contemporaneous storage” herein refers to a specific technical state where identical instances of a media file exist at the same time in both cloud storage and local device storage (e.g., as indicated through database queries and file signature matching). “Successful completion” of device readiness tests herein refers to satisfying one or more technical criteria, such as specific threshold values for device resources (e.g., battery level or available memory), and “successful completion” of media suitability tests herein refers to ascertaining (e.g., detecting or verifying) one or more media characteristics (e.g., codec compatibility or file size reduction potential). As used herein, a “minimum breakeven time” represents a predetermined (e.g., pre-calculated) technical threshold derived based on cloud storage costs, network bandwidth costs, and projected storage savings, below which transcoding a given media file would not provide sufficient technical benefit to justify resource expenditure.

These technical elements work together to implement a practical solution to the technical problem of optimizing cloud storage costs through selective transcoding of media files. The systems and methods discussed herein therefore enable intelligent resource allocation while preventing unnecessary network transfers and processing operations, thereby providing concrete technical improvements in both efficiency and cost reduction (e.g., computational, congestive, financial, or any suitable combination thereof) compared to conventional approaches that lack such precisely targeted evaluation capabilities.

In an example use case, whether acting on its own (e.g., as configured by an app) or under remote control by a controller machine, the device first runs a first phase check regarding the device’s suitability for transcoding a media file. In this example use case, the device first determines whether the app is running in the background, to avoid initiating a transcoding operation that would interfere with performance of the app (e.g., in providing services to a user). The device then evaluates its battery status and charging state, proceeding further only if sufficient power is available or the device is connected to a charger to avoid incomplete or interrupted transcoding. Next, the device checks its memory usage, verifying that adequate memory is available to transcode the media file (e.g., while remaining within one or more performance parameters). Finally, the device enforces a frequency limit, ensuring that processing sessions occur no more frequently than a predetermined threshold frequency (e.g., once every 24 hours), to maintain efficiency and prevent resource overuse). Through this sequence of checks, the device ensures that the device in its current state is suitable for transcoding the media file.

In this example use case, whether acting on its own or under control of a controller machine, the device next runs a second phase check regarding the media file’s suitability for being transcoded by the device. The device begins this second phase by checking whether the media file is locally stored at the device (e.g., indicative of being previously downloaded or otherwise accessed), such as by searching for the media file within a persistent local database (e.g., in a persistent cache) at the device. The device then verifies that the media file is legitimate (e.g., valid, authenticated, intact, complete, or any suitable combination thereof) and assesses whether its size (e.g., file size) falls within a predetermined range for media files (e.g., of reasonable size for video files). Next, the device evaluates the media file’s bitrate to ensure it is within a predetermined range of bitrates and then confirms that the compression codec used is supported as a source codec for transcoding. Using the media file’s current bitrate, current file size, predicted (e.g., estimated or projected) transcoded bitrate, and predicted transcoded file size, the device calculates the estimated file size savings and determines whether the file size reduction exceeds a predefined threshold reduction. Finally, the device checks to ensure the media file is not being used in contexts where transcoding would be undesirable, such as being shared among multiple users or being used in a theme of the app. Only after passing all these checks does the device proceed to initiate a transcoding of the media file.

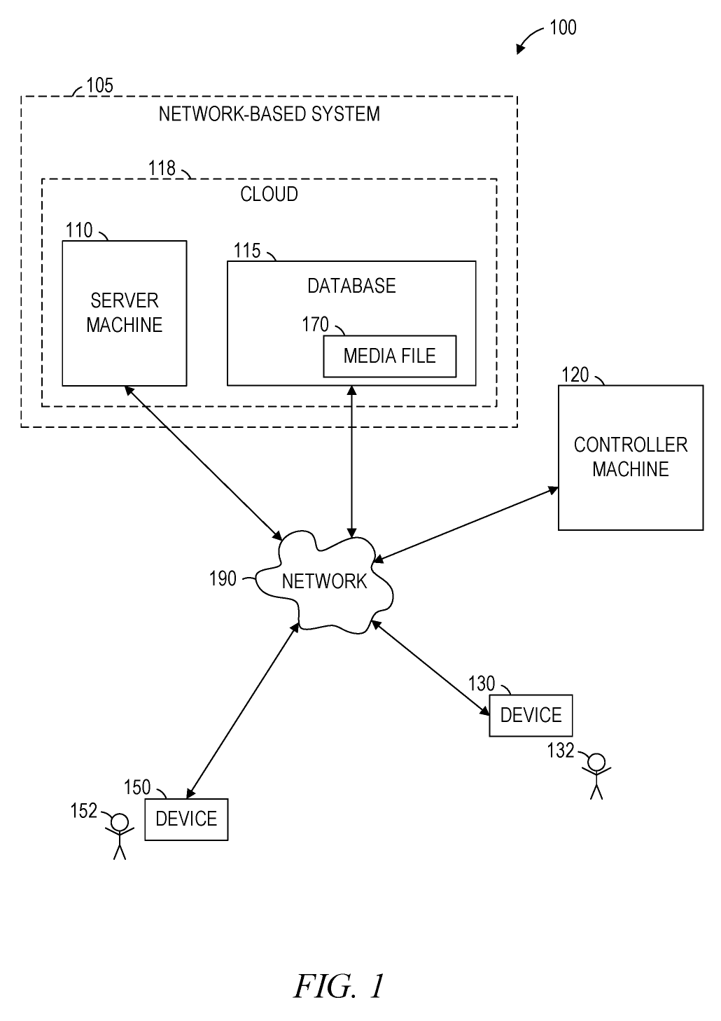

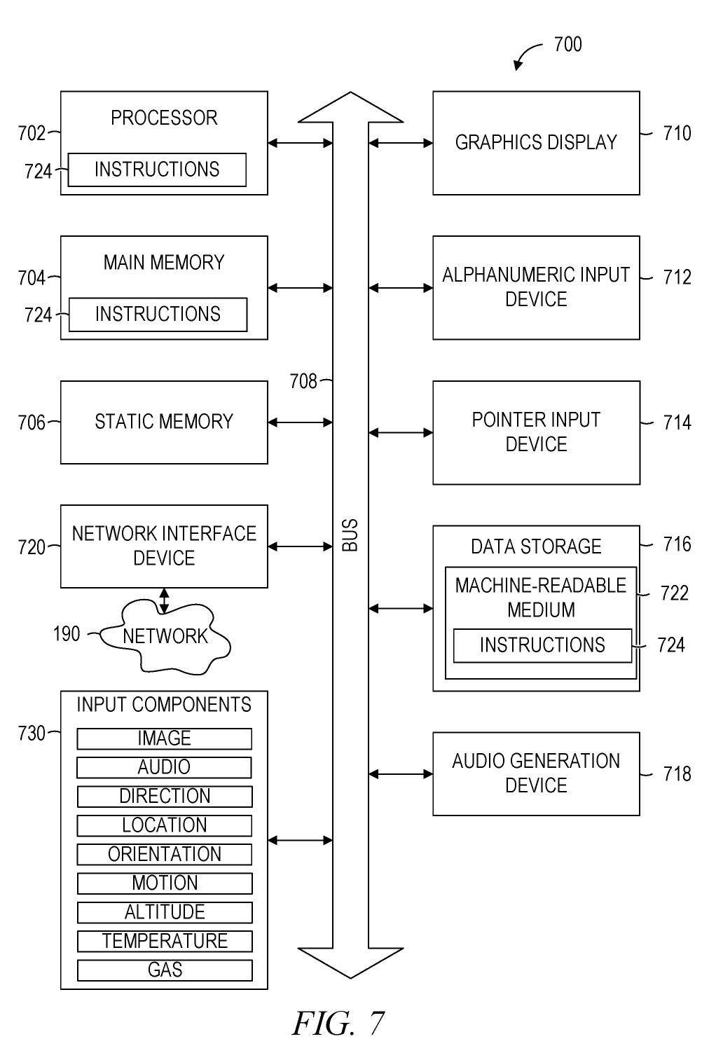

FIG. 1 is a network diagram illustrating a network environment suitable for opportunistic transcoding of a media file, according to some examples. The network environment 100 includes a server machine 110, a database 115, a controller machine 120, and devices 130 and 150, all communicatively coupled to each other via a network 190. The database 115 stores a media file 170 (e.g., a video file, an audio file, a presentation, or any suitable combination thereof). The server machine 110, with or without the database 115, may form all or part of a cloud 118 (e.g., a geographically distributed set of multiple machines configured to function as a single server), which may form all or part of a network-based system 105 (e.g., a cloud-based server system configured to provide one or more network-based services to the devices 130 and 150). The server machine 110, the controller machine 120, and the devices 130 and 150 may each be implemented in a special-purpose (e.g., specialized) computer system, in whole or in part, as described below with respect to FIG. 7.

Also shown in FIG. 1 are users 132 and 152. One or both of the users 132 and 152 may be a human user (e.g., a human being), a machine user (e.g., a computer configured by a software program to interact with the device 130 or 150), or any suitable combination thereof (e.g., a human assisted by a machine, or a machine supervised by a human). The user 132 is associated with the device 130 and may be a user of the device 130. For example, the device 130 may be a desktop computer, a vehicle computer, a home media system (e.g., a home theater system or other home entertainment system), a tablet computer, a navigational device, a portable media device, a smart phone, or a wearable device (e.g., a smart watch, smart glasses, smart clothing, or smart jewelry) belonging to the user 132. Likewise, the user 152 is associated with the device 150 and may be a user of the device 150. As an example, the device 150 may be a desktop computer, a vehicle computer, a home media system (e.g., a home theater system or other home entertainment system), a tablet computer, a navigational device, a portable media device, a smart phone, or a wearable device (e.g., a smart watch, smart glasses, smart clothing, or smart jewelry) belonging to the user 152.

Any of the systems or machines (e.g., databases and devices) shown in FIG. 1 may be, include, or otherwise be implemented in a special-purpose (e.g., specialized or otherwise non-conventional and non-generic) computer that has been modified to perform one or more of the functions described herein for that system or machine (e.g., configured or programmed by special-purpose software, such as one or more software modules of a special-purpose application, operating system, firmware, middleware, or other software program). For example, a special-purpose computer system able to implement any one or more of the methodologies described herein is discussed below with respect to FIG. 7, and such a special-purpose computer may accordingly be a means for performing any one or more of the methodologies discussed herein. Within the technical field of such special-purpose computers, a special-purpose computer that has been specially modified (e.g., configured by special-purpose software) by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

As used herein, a “database” is a data storage resource and may store data structured in any of various ways, for example, as a text file, a table, a spreadsheet, a relational database (e.g., an object-relational database), a triple store, a hierarchical data store, a document database, a graph database, key-value pairs, or any suitable combination thereof. Moreover, any two or more of the systems or machines illustrated in FIG. 1 may be combined into a single system or machine, and the functions described herein for any single system or machine may be subdivided among multiple systems or machines.

The network 190 may be any network that enables communication between or among systems, machines, databases, and devices (e.g., among the server machine 110, the controller machine 120, and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone service (POTS) network), a wireless data network (e.g., a WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

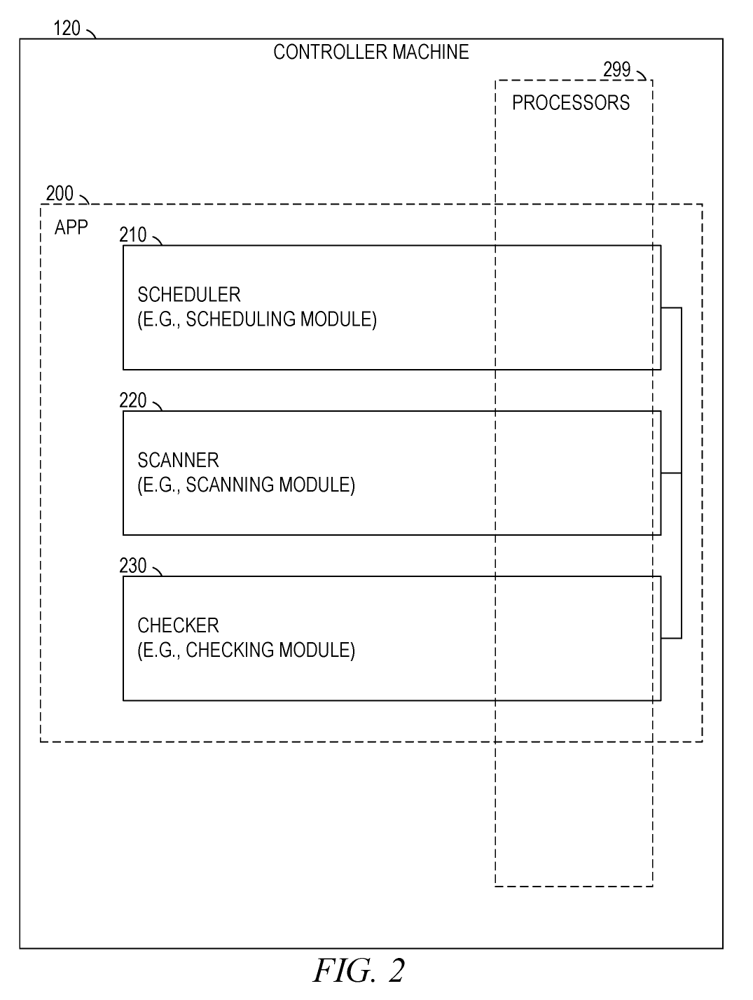

FIG. 2 is a block diagram illustrating components of the controller machine 120, as configured for opportunistic transcoding of the media file 170, according to some examples. The controller machine 120 is shown as including a scheduler 210, a scanner 220, and a checker 230, all configured to communicate with each other (e.g., via a bus, shared memory, or a switch).

As shown in FIG. 2, the scheduler 210, the scanner 220, and the checker 230 may form all or part of an app 200 (e.g., a controller app, a server-side app, or both) that is stored (e.g., installed) on the controller machine 120 (e.g., responsive to or otherwise as a result of data being received via the network 190). Furthermore, one or more processors 299 (e.g., hardware processors, digital processors, or any suitable combination thereof) may be included (e.g., temporarily or permanently) in the app 200, the scheduler 210, the scanner 220, the checker 230, or any suitable combination thereof.

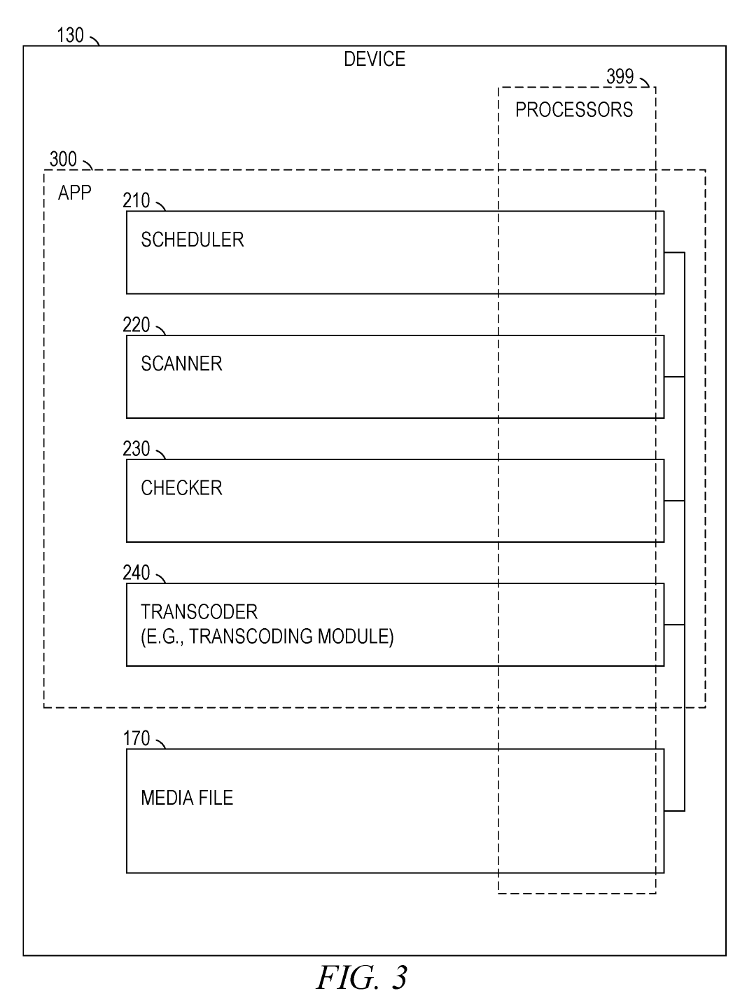

FIG. 3 is a block diagram illustrating components of the device 130, as configured for opportunistic transcoding of the media file 170, according to some examples. The device 130 is shown as including instances of the scheduler 210, the scanner 220, and the checker 230, as well as a transcoder 240 and the media file 170, all configured to communicate with each other (e.g., via a bus, shared memory, or a switch)

As shown in FIG. 3, the scheduler 210, the scanner 220, the checker 230, and the transcoder 240 may form all or part of an app 300 (e.g., a mobile app, a client-side app, or both) that is stored (e.g., installed) on the device 130 (e.g., responsive to or otherwise as a result of data being received via the network 190). Furthermore, one or more processors 399 (e.g., hardware processors, digital processors, or any suitable combination thereof) may be included (e.g., temporarily or permanently) in the app 300, the scheduler 210, the scanner 220, the checker 230, the transcoder 240, or any suitable combination thereof.

Any one or more of the components (e.g., modules) described herein may be implemented using hardware alone (e.g., one or more of the processors 299 or 399) or a combination of hardware and software. For example, any component described herein may physically include an arrangement of one or more of the processors 299 or 399 (e.g., a subset of or among the processors 299 or 399) configured to perform the operations described herein for that component. As another example, any component described herein may include software, hardware, or both, that configure an arrangement of one or more of the processors 299 or 399 to perform the operations described herein for that component. Accordingly, different components described herein may include and configure different arrangements of the processors 299 or 399 at different points in time or a single arrangement of the processors 299 or 399 at different points in time. Each component (e.g., module) described herein is an example of a means for performing the operations described herein for that component. Moreover, any two or more components described herein may be combined into a single component, and the functions described herein for a single component may be subdivided among multiple components. Furthermore, according to various examples, components described herein as being implemented within a single system or machine (e.g., a single device) may be distributed across multiple systems or machines (e.g., multiple devices).

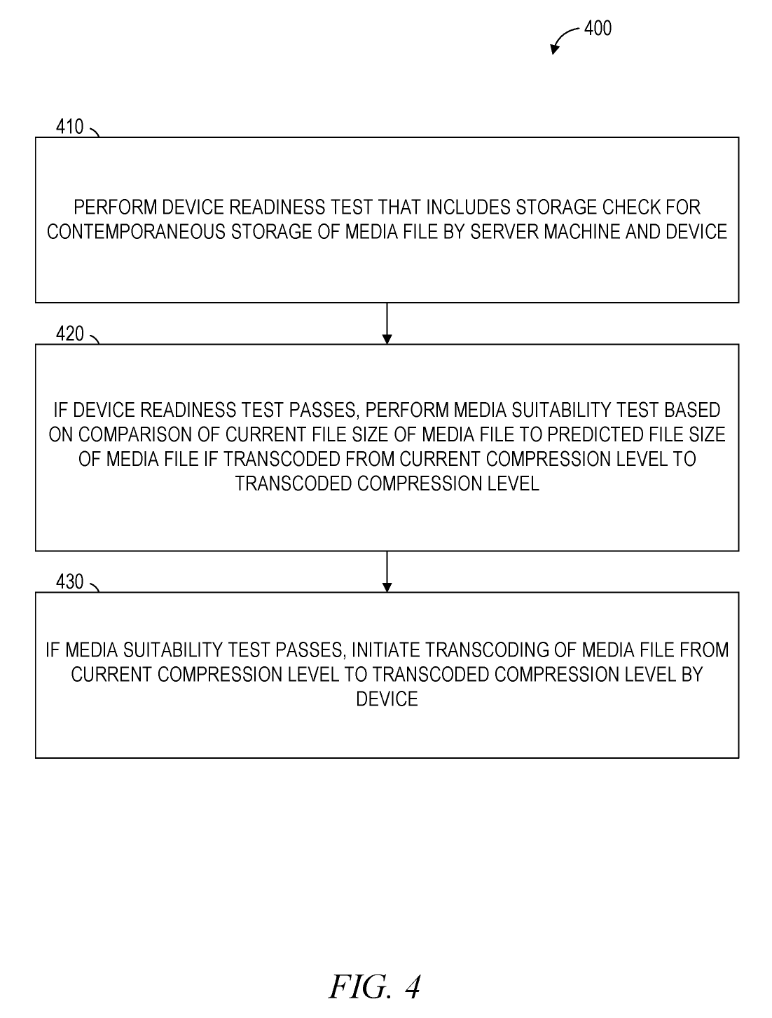

FIGS. 4-6 are flowcharts illustrating operations of the device 130 (e.g., acting on its own as configured by the app 300, or caused to act under remote control by the controller machine 120 as configured by the app 200) in performing a method 400 of opportunistic transcoding, according to some examples. Operations in the method 400 may be performed by the device 130, using components described above with respect to FIG. 3, using one or more processors (e.g., microprocessors or other hardware processors), or using any suitable combination thereof. Additionally, operations in the method 400 may be caused (e.g., triggered, commanded, prompted, or requested) by the controller machine 120, using components described above with respect to FIG. 2, using one or more processors, or using any suitable combination thereof. As shown in FIG. 4, the method 400 includes operations 410, 420, and 430.

In operation 410, the scanner 220 initiates and performs a device readiness test that checks readiness of the device 130 for transcoding the media file 170, which is stored by the server machine 110, at least. The device readiness test may be considered a first phase within a two-phase test, and the device readiness test includes a storage check for contemporaneous storage of the media file 170 by both the server machine 110 in the cloud 118 and by the device 130 locally. This check for contemporaneous storage at both the server machine 110 and the device 130 implicitly detects that the media file 170 has already been downloaded to the device 130 and, therefore, that its associated download cost has already been incurred, thus providing one indication that a favorable opportunity is present to transcode the media file 170 locally at the device 130. Other tests may also be included in the device readiness test, as described below.

In operation 420, in response to or otherwise based (e.g., exclusively or non-exclusively) on successful completion of the device readiness test in operation 410, the checker 230 initiates and performs a media suitability test that checks the media file 170 that is stored by the device 130 (e.g., in a local persistent cache). The media suitability test includes and is based on a comparison of a current file size of the media file 170, as stored by the server machine 110, to a predicted file size of the media file 170 if transcoded from a current compression level of the media file 170 (e.g., as compressed with a current compression codec) to a transcoded compression level of the media file 170 (e.g., as compressed with an alternative or otherwise different compression codec). This comparison of current and predicted file sizes provides a basis for determining whether transcoding the media file 170 would be worthwhile (e.g., where the upload cost is worth the savings in storage costs) and, thus, determining that the media file 170 is indeed presently suitable for transcoding. Other tests may also be included in the media suitability test, as described below.

In some examples, prediction of a transcoded file size is performed through analysis of the media file’s current compression characteristics and the target codec’s capabilities. The checker 230 may evaluate one or more of the current codec parameters for the media file 170, such as bitrate, resolution, frame rate, and color depth, to establish a baseline quality profile. This profile may be then mapped to equivalent quality parameters for a target codec, accounting for the target codec’s compression efficiency characteristics and quality preservation capabilities. The predicted file size accordingly may be calculated using codec-specific models for compression ratios, which may factor in both the source material characteristics and the target quality parameters.

In operation 430, in response to or otherwise based (e.g., exclusively or non-exclusively) on successful completion of the media suitability test in operation 420, the transcoder 240 initiates a transcoding of the media file 170 from the current compression level to the transcoded compression level by the device 130, which stores the media file 170 contemporaneously with the server machine. In some examples, after the initiated transcoding is complete, the device 130 proceeds to upload the resultant transcoded version of the media file 170 to the cloud 118, thus replacing the instance of the media file 170 stored in the cloud 118 with a transcoded instance that has a smaller file size (e.g., the predicted file size).

In some examples, the initiated transcoding process is enhanced by dynamic resource allocation and scheduling. The transcoder 240 may monitor availability of device resources, such as processor utilization, memory usage, network activity, and power status, to determine optimal transcoding windows. The transcoder 240 may accordingly implement dynamically adaptive processing that adjusts one or more quality parameters, with consequent effect on processing speed, based on the available resources on the device 130 while maintaining output quality within acceptable thresholds. This dynamic resource usage helps provide efficient resource utilization while preventing device performance degradation during transcoding operations.

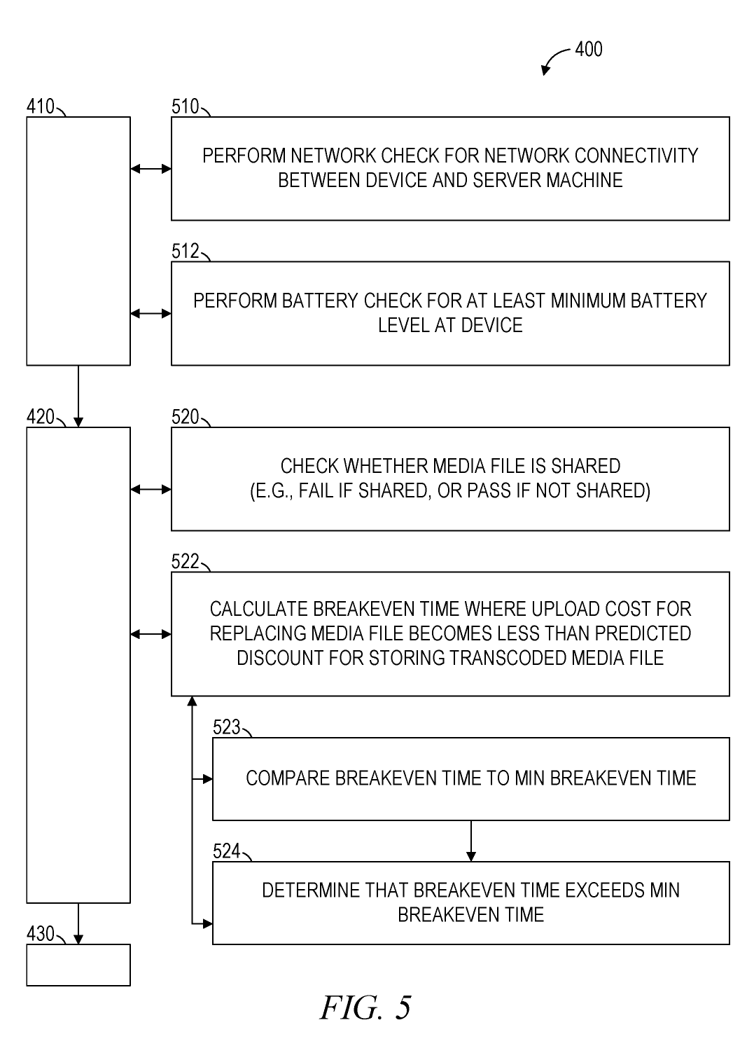

As shown in FIG. 5, in addition to any one or more of the operations previously described, the method 400 may include one or more of operations 510, 512, 520, 522, 523, and 524. One or more of operations 510 and 512 may be performed as part (e.g., a precursor task, a subroutine, or a portion) of operation 410, in which the scanner 220 initiates and performs the device readiness test (e.g., as a first phase in a two-phase test).

In operation 510, the device readiness test includes a network check for network connectivity of the device 130 to the server machine 110 that contemporaneously stores the media file 170 with the device. Accordingly, in operation 510, the scanner 220 initiates and performs this network check. In some examples, the network check determines whether a network connection (e.g., cellular, Wi-Fi, or satellite) is active and permits network communication between the device 130 and the server machine 110. This network check helps avoid starting a transcoding operation without an ability to upload the transcoded version of the media file 170 promptly afterwards. Unsuccessful completion (e.g., failure) of this network check may terminate and fail the device readiness test being performed in operation 410.

In operation 520, the device readiness test includes a battery check for at least a minimum battery level at the device 130 that stores the media file 170 contemporaneously with the server machine 110. Accordingly, in operation 520, the checker 230 initiates and performs this battery check. In some examples, the minimum battery level is predetermined. In certain examples, the minimum battery level is dynamically determined (e.g., calculated) based on one or more attributes of the media file 170 (e.g., current file size, current bitrate, resolution, and framerate), one or more attributes of the device 130 (e.g., manufacturer, model, age, operating system, processor, and expected battery life), or any suitable combination thereof. This battery check helps avoid starting a transcoding operation likely to fail or be interrupted due to power loss. Unsuccessful completion (e.g., failure) of this battery check may terminate and fail the device readiness test being performed in operation 410.

One or more of operations 520 and 522 may be performed as part (e.g., a precursor task, a subroutine, or a portion) of operation 420, in which the checker 230 initiates and performs the media suitability test (e.g., as a second phase in a two-phase test).

In operation 520, the media suitability test is configured to fail if the media file 170, which is contemporaneously stored by the server machine 110 and by the device 130, is shared among multiple users (e.g., two or more different uses of the server machine 110, the network-based system 105, the cloud 118, the controller machine 120, or any suitable combination thereof). Conversely, the media suitability test is configured to pass if the media file 170 is not shared among multiple users. Accordingly, in operation 520, the checker 230 checks whether the media file 170 is shared by more than one user. This sharing check helps avoid starting a transcoding operation on a media file (e.g., media file 170) that might be in active use by another user (e.g., open for reading or writing) at the server machine 110 (e.g., as manager of the cloud 118). Unsuccessful completion (e.g., failure) of this sharing check may terminate and fail the media suitability test being performed in operation 420.

In operation 522, the media suitability test includes or is otherwise based on calculating a breakeven time (e.g., a breakeven timepoint) at which an upload cost of replacing the media file 170, as stored by the server machine 110 (e.g., as manager of the cloud 118), with a transcoded version of the media file 170, is superseded (e.g., exceeded or otherwise transgressed) by a predicted discount resultant from the server machine 110 storing the predicted file size of the transcoded media file 170 instead of the current file size of the media file 170, until at least the breakeven time. Accordingly, in operation 522, the checker 230 performs this calculation of the breakeven time, which may be used as a basis for determining successful or unsuccessful completion of the media suitability test being performed in operation 420. This calculated breakeven time provides a basis for determining whether transcoding the media file 170 would be worthwhile, for purposes of the media readiness test being performed in operation 420.

In some examples, calculation of the breakeven time incorporates multiple cost factors, such as storage costs per gigabyte in the cloud 118, network bandwidth costs per upload operation to the cloud 118, and predicted storage cost savings from the predicted reduced file size of the media file 170. The checker 230 may calculate a total cost of the transcoding operation (CT) as the sum of the upload bandwidth cost (Cu) and processing overhead cost (Cp). The monthly storage cost savings (Sm) may be determined (e.g., by the checker 230) by multiplying the storage cost rate (Rs) by the difference between the current and predicted file sizes. The breakeven time (Tb) therefore may be then computed as Tb = CT/Sm, representing the number of months required for the storage cost savings to offset the transcoding and upload costs.

One or more of operations 523 and 524 may be performed as part (e.g., a precursor task, a subroutine, or a portion) of operation 522, in which the checker 230 calculates the breakeven time at with the upload cost of uploading a transcoded instance of the media file 170 becomes worth the predicted cost savings that would result from doing so.

In operation 523, the checker 230 compares the calculated breakeven time to a minimum breakeven time (e.g., a predetermined or dynamically determined minimum breakeven time) at which the upload cost of replacing the media file 170, as stored by the server machine 110 (e.g., as manager of the cloud 118), with a transcoded version of the media file 170 is superseded by the predicted discount (e.g., storage cost savings) that would result from the server machine 110 storing the predicted file size of the media file 170, instead of the current file size of the media file 170, until at least the calculated breakeven time.

In operation 524, the checker 230, based on the comparison performed in operation 523, determines that the calculated breakeven time exceeds the minimum breakeven time at which the upload cost of replacing the media file 170, as stored by the server machine 110 (e.g., as manager of the cloud 118), with the transcoded version of the media file 170 is superseded by the predicted discount that would result from the server machine 110 storing the predicted file size of the media file 170, instead of the current file size of the media file 170, until at least the calculated breakeven time.

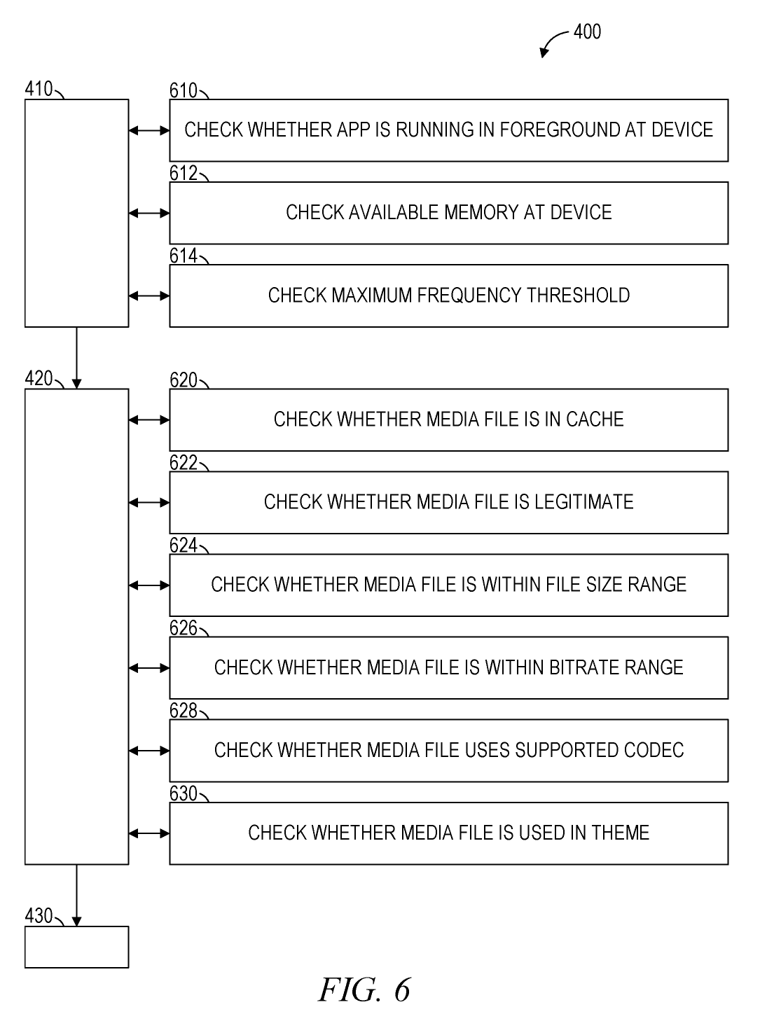

As shown in FIG. 6, in addition to any one or more of the operations previously described, the method 400 may include one or more of operations 610, 612, 614, 620, 622, 624, 626, 628, and 630. One or more of operations 610, 612, and 614 may be performed as part (e.g., a precursor task, a subroutine, or a portion) of operation 410, in which the scanner 220 initiates and performs the device readiness test.

In operation 610, the scanner 220 checks whether the app 300 is currently running in the foreground (e.g., as a foreground process, as opposed to running in the background as a background process) on the device 130. In some examples, the device readiness test being performed in operation 410 is configured to fail if the app 300 is running in the foreground, which may help avoid causing degradation in performance of the app 300 due to initiating a transcoding of the media file 170 on the device 130. Unsuccessful completion (e.g., failure) of this foreground-background check may terminate and fail the device readiness test being performed in operation 410.

In operation 612, the scanner 220 checks whether there is sufficient available memory (e.g., above a minimum threshold of free unallocated memory) at or on the device 130. In some examples, the device readiness test being performed in operation 410 is configured to fail if the memory available for use by the device 130 is below a minimum threshold amount (e.g., predetermined or dynamically determined based on one or more attributes of the media file 170 (e.g., current file size, current bitrate, resolution, and framerate), one or more attributes of the device 130 (e.g., manufacturer, model, age, operating system, processor, and standard memory configuration), or any suitable combination thereof. In some examples, the scanner 220 passes this memory check if the local memory pressure on the device 130 is below a maximum threshold level. Unsuccessful completion (e.g., failure) of this memory check may terminate and fail the device readiness test being performed in operation 410.

In operation 614, the scheduler 210 checks whether initiation of a transcoding operation on the media file 170 would cause a maximum frequency threshold (e.g., a maximum transcoding frequency) to be exceeded. In practice, the device 130 may frequently access (e.g., download) many media files, like the media file 170, and it may be beneficial to avoid using the device 130 too often to transcode media files, even if all other factors in determining appropriateness are found. Thus, this frequency check helps cap transcoding operations at the maximum frequency and avoid overconsumption of resources on the device 130 or its network connections. Unsuccessful completion (e.g., failure) of this frequency check may terminate and fail the device readiness test being performed in operation 410.

One or more of operations 620, 622, 624, 626, 628, and 630 may be performed as part (e.g., a precursor task, a subroutine, or a portion) of operation 420, in which the checker 230 initiates and performs the media suitability test.

In operation 620, the checker 230 checks whether the media file 170 is local stored by the device 130 in a cache memory (e.g., a persistent local cache memory). This check may be included in the storage check for contemporaneous storage of the media file 170 by both the server machine 110 and by the device 130, as described above with respect to operation 410. Thus, in some examples, this cache check helps determine (e.g., detect) that that the media file 170 has already been downloaded to the device 130 and, therefore, that its associated cost to download it from the cloud 118 has already been incurred. Unsuccessful completion (e.g., failure) of this cache check may terminate and fail the media suitability test being performed in operation 420.

In operation 622, the checker 230 checks whether the media file 170 is legitimate. According to various examples, a media file (e.g., the media file 170) is deemed to be legitimate if the media file is valid, authenticated, intact, complete, or any suitable combination thereof. One or more other indicators of legitimacy may be implemented (e.g., by the app 200 or 300) in certain examples. Unsuccessful completion (e.g., failure) of this file legitimacy check may terminate and fail the media suitability test being performed in operation 420.

In operation 624, the checker 230 checks whether the current file size of the media file 170 is within a predetermined file size range for media files (e.g., a reasonable file size for video files). This file size check helps avoid further processing of files that are too small to likely provide significant reduction of storage costs, too large to be processed within a predetermined window of time, or too small or large to likely be a media file at all, such as an erroneously labeled file. Unsuccessful completion (e.g., failure) of this file size check may terminate and fail the media suitability test being performed in operation 420.

In operation 626, the checker 230 checks whether the current bitrate of the media file 170 is within a predetermined bitrate range for media files (e.g., a reasonable bitrate for video files). This bitrate check helps avoid further processing of files whose bitrates are too small or large to be transcoded from, or to, any of the compression codecs supported by the app 200 or 300. Unsuccessful completion (e.g., failure) of this bitrate check may terminate and fail the media suitability test being performed in operation 420.

In operation 628, the checker 230 checks that the compression codec with which the media file 170 was previously transcoded to obtain its current file size is among the one or more compression codecs that are supported by the app 200 or 300 as an available source codec from which to transcode to a different, destination codec. This source codec check helps avoid further processing of any media file whose compression format, encoding, colorspace, or other codec-specific attribute is unsupported by the transcoder 240 of the app 200 or 300. Unsuccessful completion (e.g., failure) of this codec check may terminate and fail the media suitability test being performed in operation 420.

In operation 630, the checker 230 checks whether the media file 170 is being used as part of a theme within the app 200 or 300. In various examples, one or more media files (e.g., media file 170) may be incorporated (e.g., as a link) into one or more themes, as part of their customization, personalization, or other configuration. Accordingly, this theme check helps avoid further processing of any media file that may be actively or otherwise currently used in a context (e.g., a theme) where replacing it within the cloud 118 would be undesirable. In some examples, this theme check is similar in effect to the sharing check for whether the media file 170 is currently shared by multiple users, as described above with respect to operation 520. Unsuccessful completion (e.g., failure) of this theme check may terminate and fail the media suitability test being performed in operation 420.

According to various examples, one or more of the methodologies described herein may facilitate transcoding of one or more media files (e.g., opportunistic transcoding of the media file 170). Moreover, one or more of the methodologies described herein may facilitate opportunistic transcoding of one or more media files (e.g., media file 170). Hence, one or more of the methodologies described herein may facilitate updating compression codecs for such media files, as well as reductions in file sizes of such media files and consequent reductions in cloud storage costs for such media files, compared to capabilities of pre-existing systems and methods.

When these effects are considered in aggregate, one or more of the methodologies described herein may obviate a need for certain efforts or resources that otherwise would be involved in determining which media files are suitable for transcoding and which devices are suitable for transcoding media files. Efforts expended by a user in making such determinations may be reduced by use of (e.g., reliance upon) a special-purpose machine that implements one or more of the methodologies described herein. Computing resources used by one or more systems or machines (e.g., within the network environment 100) may similarly be reduced (e.g., compared to systems or machines that lack the structures discussed herein or are otherwise unable to perform the functions discussed herein). Examples of such computing resources include processor cycles, network traffic, computational capacity, main memory usage, graphics rendering capacity, graphics memory usage, data storage capacity, power consumption, and cooling capacity.

FIG. 7 is a block diagram illustrating components of a machine 700, according to some examples, able to read instructions 724 from a machine-readable medium 722 (e.g., a non-transitory machine-readable medium, a machine-readable storage medium, a computer-readable storage medium, or any suitable combination thereof) and perform any one or more of the methodologies discussed herein, in whole or in part. Specifically, FIG. 7 shows the machine 700 in the example form of a computer system (e.g., a computer) within which the instructions 724 (e.g., software, a program, an application, an applet, an app, or other executable code) for causing the machine 700 to perform any one or more of the methodologies discussed herein may be executed, in whole or in part.

In alternative examples, the machine 700 operates as a standalone device or may be communicatively coupled (e.g., networked) to other machines. In a networked deployment, the machine 700 may operate in the capacity of a server machine or a client machine in a server-client network environment, or as a peer machine in a distributed (e.g., peer-to-peer) network environment. The machine 700 may be a server computer, a client computer, a personal computer (PC), a tablet computer, a laptop computer, a netbook, a cellular telephone, a smart phone, a set-top box (STB), a personal digital assistant (PDA), a web appliance, a network router, a network switch, a network bridge, or any machine capable of executing the instructions 724, sequentially or otherwise, that specify actions to be taken by that machine. Further, while only a single machine is illustrated, the term “machine” shall also be taken to include any collection of machines that individually or jointly execute the instructions 724 to perform all or part of any one or more of the methodologies discussed herein.

The machine 700 includes a processor 702 (e.g., one or more central processing units (CPUs), one or more graphics processing units (GPUs), one or more digital signal processors (DSPs), one or more application specific integrated circuits (ASICs), one or more radio-frequency integrated circuits (RFICs), one or more tensor processing units (TPUs), one or more neural processing units (NPUs), one or more vision processing units (VPUs), one or more machine-learning accelerators, one or more artificial-intelligence accelerators, one or more neuromorphic processors, one or more quantum processors, or any suitable combination thereof), a main memory 704, and a static memory 706, which are configured to communicate with each other via a bus 708. The processor 702 contains solid-state digital microcircuits (e.g., electronic, optical, biological, or any suitable combination thereof) that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

In some examples, the processor 702 is a multicore CPU (e.g., a dual-core CPU, a quad-core CPU, an 8-core CPU, or a 128-core CPU) within which each of multiple cores behaves as a separate processor that is able to perform any one or more of the methodologies discussed herein, in whole or in part. Parallel processing on one or more multicore processors may be implemented via one or more suitable architectures, such as superscalar, very long instruction word (VLIW), vector processing, or single-instruction/multiple-data (SIMD), which allow each core to run separate instruction streams concurrently. A processor may be emulated in software, running on a physical processor, as a virtual processor or virtual circuit. The virtual processor may behave like an independent processor but is implemented in software rather than hardware. Although the beneficial effects described herein may be provided by the machine 700 with at least the processor 702, these same beneficial effects may be provided by a different kind of machine that contains no processors (e.g., a purely mechanical system, a purely hydraulic system, or a hybrid mechanical-hydraulic system), if such a processor-less machine is configured to perform one or more of the methodologies described herein.

The machine 700 may further include a graphics display 710 (e.g., a plasma display panel (PDP), a light emitting diode (LED) display, a liquid crystal display (LCD), a projector, a cathode ray tube (CRT), or any other display capable of displaying graphics or video). The machine 700 may also include an alphanumeric input device 712 (e.g., a keyboard or keypad), a pointer input device 714 (e.g., a mouse, a touchpad, a touchscreen, a trackball, a joystick, a stylus, a motion sensor, an eye tracking device, a data glove, or other pointing instrument), a data storage 716, an audio generation device 718 (e.g., a sound card, an amplifier, a speaker, a headphone jack, or any suitable combination thereof), and a network interface device 720.

The data storage 716 (e.g., a data storage device) includes the machine-readable medium 722 (e.g., a tangible and non-transitory machine-readable storage medium) on which are stored the instructions 724 embodying any one or more of the methodologies or functions described herein. The instructions 724 may also reside, completely or at least partially, within the main memory 704, within the static memory 706, within the processor 702 (e.g., within the processor’s cache memory), or any suitable combination thereof, before or during execution thereof by the machine 700. Accordingly, the main memory 704, the static memory 706, and the processor 702 may be considered machine-readable media (e.g., tangible and non-transitory machine-readable media). The instructions 724 may be transmitted or received over the network 190 via the network interface device 720. For example, the network interface device 720 may communicate the instructions 724 using any one or more transfer protocols (e.g., hypertext transfer protocol (HTTP)).

In some examples, the machine 700 may be a portable computing device (e.g., a smart phone, a tablet computer, or a wearable device) and may have one or more additional input components 730 (e.g., sensors or gauges). Examples of such input components 730 include an image input component (e.g., one or more cameras), an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), a temperature input component (e.g., a thermometer), and a gas detection component (e.g., a gas sensor). Input data gathered by any one or more of these input components 730 may be accessible and available for use by any of the modules described herein (e.g., with suitable privacy notifications and protections, such as opt-in consent or opt-out consent, implemented in accordance with user preference, applicable regulations, or any suitable combination thereof).

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of carrying (e.g., storing or communicating) the instructions 724 for execution by the machine 700, such that the instructions 724, when executed by one or more processors of the machine 700 (e.g., processor 702), cause the machine 700 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible and non-transitory data repositories (e.g., data volumes) in the example form of a solid-state memory chip, an optical disc, a magnetic disc, or any suitable combination thereof.

A “non-transitory” machine-readable medium, as used herein, specifically excludes propagating signals per se. According to various examples, the instructions 724 for execution by the machine 700 can be communicated via a carrier medium (e.g., a machine-readable carrier medium). Examples of such a carrier medium include a non-transient carrier medium (e.g., a non-transitory machine-readable storage medium, such as a solid-state memory that is physically movable from one place to another place) and a transient carrier medium (e.g., a carrier wave or other propagating signal that communicates the instructions 724).

Certain examples are described herein as including modules. Modules may constitute software modules (e.g., code stored or otherwise embodied in a machine-readable medium or in a transmission medium), hardware modules, or any suitable combination thereof. A “hardware module” is a tangible (e.g., non-transitory) physical component (e.g., a set of one or more processors) capable of performing certain operations and may be configured or arranged in a certain physical manner. In various examples, one or more computer systems or one or more hardware modules thereof may be configured by software (e.g., an application or portion thereof) as a hardware module that operates to perform operations described herein for that module.

In some examples, a hardware module may be implemented mechanically, electronically, hydraulically, or any suitable combination thereof. For example, a hardware module may include dedicated circuitry or logic that is permanently configured to perform certain operations. A hardware module may be or include a special-purpose processor, such as a field programmable gate array (FPGA) or an ASIC. A hardware module may also include programmable logic or circuitry that is temporarily configured by software to perform certain operations. As an example, a hardware module may include software encompassed within a CPU or other programmable processor. It will be appreciated that the decision to implement a hardware module mechanically, hydraulically, in dedicated and permanently configured circuitry, or in temporarily configured circuitry (e.g., configured by software) may be driven by cost and time considerations.

Accordingly, the phrase “hardware module” should be understood to encompass a tangible entity that may be physically constructed, permanently configured (e.g., hardwired), or temporarily configured (e.g., programmed) to operate in a certain manner or to perform certain operations described herein. Furthermore, as used herein, the phrase “hardware-implemented module” refers to a hardware module. Considering examples in which hardware modules are temporarily configured (e.g., programmed), each of the hardware modules need not be configured or instantiated at any one instance in time. For example, where a hardware module includes a CPU configured by software to become a special-purpose processor, the CPU may be configured as respectively different special-purpose processors (e.g., each included in a different hardware module) at different times. Software (e.g., a software module) may accordingly configure one or more processors, for example, to become or otherwise constitute a particular hardware module at one instance of time and to become or otherwise constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over circuits and buses) between or among two or more of the hardware modules. In examples in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory (e.g., a memory device) to which it is communicatively coupled. A further hardware module may then, at a later time, access the memory to retrieve and process the stored output. Hardware modules may also initiate communications with input or output devices, and can operate on a resource (e.g., a collection of information from a computing resource).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module in which the hardware includes one or more processors. Accordingly, the operations described herein may be at least partially processor-implemented, hardware-implemented, or both, since a processor is an example of hardware, and at least some operations within any one or more of the methods discussed herein may be performed by one or more processor-implemented modules, hardware-implemented modules, or any suitable combination thereof.

Moreover, such one or more processors may perform operations in a “cloud computing” environment or as a service (e.g., within a “software as a service” (SaaS) implementation). For example, at least some operations within any one or more of the methods discussed herein may be performed by a group of computers (e.g., as examples of machines that include processors), with these operations being accessible via a network (e.g., the Internet) and via one or more appropriate interfaces (e.g., an application program interface (API)). The performance of certain operations may be distributed among the one or more processors, whether residing only within a single machine or deployed across a number of machines. In some examples, the one or more processors or hardware modules (e.g., processor-implemented modules) may be located in a single geographic location (e.g., within a home environment, an office environment, or a server farm). In other examples, the one or more processors or hardware modules may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and their functionality presented as separate components and functions in example configurations may be implemented as a combined structure or component with combined functions. Similarly, structures and functionality presented as a single component may be implemented as separate components and functions. These and other variations, modifications, additions, and improvements fall within the scope of the subject matter herein.

Some portions of the subject matter discussed herein may be presented in terms of algorithms or symbolic representations of operations on data stored as bits or binary digital signals within a memory (e.g., a computer memory or other machine memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “accessing,” “processing,” “detecting,” “computing,” “calculating,” “determining,” “generating,” “presenting,” “displaying,” or the like refer to actions or processes performable by a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated descriptions describe various examples of methods, machine-readable media, and systems (e.g., machines, devices, or other apparatus) discussed herein. Any one or more features of an example, taken in isolation or combination, should be considered as being within the disclosure of this application.

A first example provides a method comprising:
by one or more processors, performing a device readiness test that checks readiness of a device for transcoding a media file stored by a server machine, the device readiness test including a storage check for contemporaneous storage of the media file by both the server machine and the device;
by the one or more processors, based on successful completion of the device readiness test, performing a media suitability test that checks the media file stored by the device, the media suitability test being based on comparison of a current file size of the media file stored by the server machine to a predicted file size of the media file if transcoded from a current compression level of the media file to a transcoded compression level of the media file; and
by the one or more processors, based on successful completion of the media suitability test, initiating a transcoding of the media file from the current compression level to the transcoded compression level by the device that stores the media file contemporaneously with the server machine.

A second example provides a method according to the first example, wherein:
the device readiness test includes a network check for network connectivity of the device to the server machine that contemporaneously stores the media file with the device.

A third example provides a method according to the first example or the second example, wherein:
the device readiness test includes a battery check for at least a minimum battery level at the device that stores the media file contemporaneously with the server machine.

A fourth example provides a method according to any of the first through third examples, wherein:
only the successful completion of the device readiness test triggers the performing of the media suitability test on the media file stored by the device; and
the initiating of the transcoding of the media file is based on both the successful completion of the device readiness test and the successful completion of the media suitability test.

A fifth example provides a method according to any of the first through fourth examples, wherein:
the media suitability test is configured to fail if the media file contemporaneously stored by the server machine and by the device is shared among multiple users; and
the media suitability test is configured to pass if the media file contemporaneously stored by the server machine and by the device is not shared among multiple users.

A sixth example provides a method according to any of the first through fifth examples, wherein:
the media suitability test includes calculating a breakeven time at which an upload cost of replacing the media file stored by the server machine with a transcoded version of the media file is superseded by a predicted discount resultant from the server machine storing the predicted file size of the media file instead of the current file size of the media file until at least the breakeven time.

A seventh example provides a method according to the sixth example, wherein:
the media suitability test includes:
comparing the calculated breakeven time to a minimum breakeven time at which the upload cost of replacing the media file stored by the server machine with a transcoded version of the media file is superseded by the predicted discount resultant from the server machine storing the predicted file size of the media file instead of the current file size of the media file until at least the calculated breakeven time; and
determining that the calculated breakeven time fails to exceed the minimum breakeven time at which the upload cost of replacing the media file stored by the server machine with the transcoded version of the media file is superseded by the predicted discount resultant from the server machine storing the predicted file size of the media file instead of the current file size of the media file until at least the calculated breakeven time.

An eighth example provides a machine-readable medium (e.g., a non-transitory machine-readable storage medium) comprising instructions that, when executed by one or more processors of a machine, cause the machine to perform operations comprising:
performing a device readiness test that checks readiness of a device for transcoding a media file stored by a server machine, the device readiness test including a storage check for contemporaneous storage of the media file by both the server machine and the device;
based on successful completion of the device readiness test, performing a media suitability test that checks the media file stored by the device, the media suitability test being based on comparison of a current file size of the media file stored by the server machine to a predicted file size of the media file if transcoded from a current compression level of the media file to a transcoded compression level of the media file; and
based on successful completion of the media suitability test, initiating a transcoding of the media file from the current compression level to the transcoded compression level by the device that stores the media file contemporaneously with the server machine.

A ninth example provides a machine-readable medium according to the eighth example, wherein:
the device readiness test includes a network check for network connectivity of the device to the server machine that contemporaneously stores the media file with the device.

A tenth example provides a machine-readable medium according to the eighth example or the ninth example, wherein:
the device readiness test includes a battery check for at least a minimum battery level at the device that stores the media file contemporaneously with the server machine.

An eleventh example provides a machine-readable medium according to any of the eighth through tenth examples, wherein:
only the successful completion of the device readiness test triggers the performing of the media suitability test on the media file stored by the device; and
the initiating of the transcoding of the media file is based on both the successful completion of the device readiness test and the successful completion of the media suitability test.

A twelfth example provides a machine-readable medium according to any of the eighth through eleventh examples, wherein:
the media suitability test is configured to fail if the media file contemporaneously stored by the server machine and by the device is shared among multiple users; and
the media suitability test is configured to pass if the media file contemporaneously stored by the server machine and by the device is not shared among multiple users.

A thirteenth example provides a machine-readable medium according to any of the eighth through twelfth examples, wherein:
the media suitability test includes calculating a breakeven time at which an upload cost of replacing the media file stored by the server machine with a transcoded version of the media file is superseded by a predicted discount resultant from the server machine storing the predicted file size of the media file instead of the current file size of the media file until at least the breakeven time.

A fourteenth example provides a machine-readable medium according to the thirteenth example, wherein:
the media suitability test includes:
comparing the calculated breakeven time to a minimum breakeven time at which the upload cost of replacing the media file stored by the server machine with a transcoded version of the media file is superseded by the predicted discount resultant from the server machine storing the predicted file size of the media file instead of the current file size of the media file until at least the calculated breakeven time; and
determining that the calculated breakeven time fails to exceed the minimum breakeven time at which the upload cost of replacing the media file stored by the server machine with the transcoded version of the media file is superseded by the predicted discount resultant from the server machine storing the predicted file size of the media file instead of the current file size of the media file until at least the calculated breakeven time.

A fifteenth example provides a system (e.g., a computer system, a computing device, or other computing machine) comprising:
one or more processors; and
a memory storing instructions that, when executed by at least one processor among the one or more processors, cause the system to perform operations comprising:
performing a device readiness test that checks readiness of a device for transcoding a media file stored by a server machine, the device readiness test including a storage check for contemporaneous storage of the media file by both the server machine and the device;
based on successful completion of the device readiness test, performing a media suitability test that checks the media file stored by the device, the media suitability test being based on comparison of a current file size of the media file stored by the server machine to a predicted file size of the media file if transcoded from a current compression level of the media file to a transcoded compression level of the media file; and
based on successful completion of the media suitability test, initiating a transcoding of the media file from the current compression level to the transcoded compression level by the device that stores the media file contemporaneously with the server machine.

A sixteenth example provides a system according to the fifteenth example, wherein:
the device readiness test includes a network check for network connectivity of the device to the server machine that contemporaneously stores the media file with the device.

A seventeenth example provides a system according to the fifteenth example or the sixteenth example, wherein:
the device readiness test includes a battery check for at least a minimum battery level at the device that stores the media file contemporaneously with the server machine.

An eighteenth example provides a system according to any of the fifteenth through seventeenth examples, wherein:
only the successful completion of the device readiness test triggers the performing of the media suitability test on the media file stored by the device; and
the initiating of the transcoding of the media file is based on both the successful completion of the device readiness test and the successful completion of the media suitability test.

A nineteenth example provides a system according to any of the fifteenth through eighteenth examples, wherein:
the media suitability test is configured to fail if the media file contemporaneously stored by the server machine and by the device is shared among multiple users; and
the media suitability test is configured to pass if the media file contemporaneously stored by the server machine and by the device is not shared among multiple users.

A twentieth example provides a system according to any of the fifteenth through nineteenth examples, wherein:
the media suitability test includes calculating a breakeven time at which an upload cost of replacing the media file stored by the server machine with a transcoded version of the media file is superseded by a predicted discount resultant from the server machine storing the predicted file size of the media file instead of the current file size of the media file until at least the breakeven time.

A twenty-first example provides a carrier medium carrying machine-readable instructions for controlling a machine to carry out the operations (e.g., method operations) performed in any one of the previously described examples.

What is claimed is:

1. A method comprising:
by one or more processors, performing a device readiness test that checks readiness of a device for transcoding a media file stored by a server machine, the device readiness test including a storage check for contemporaneous storage of the media file by both the server machine and the device;
by the one or more processors, based on successful completion of the device readiness test, performing a media suitability test that checks the media file stored by the device, the media suitability test being based on comparison of a current file size of the media file stored by the server machine to a predicted file size of the media file if transcoded from a current compression level of the media file to a transcoded compression level of the media file; and
by the one or more processors, based on successful completion of the media suitability test, initiating a transcoding of the media file from the current compression level to the transcoded compression level by the device that stores the media file contemporaneously with the server machine.

2. The method of claim 1, wherein:
the device readiness test includes a network check for network connectivity of the device to the server machine that contemporaneously stores the media file with the device.

3. The method of claim 1, wherein:
the device readiness test includes a battery check for at least a minimum battery level at the device that stores the media file contemporaneously with the server machine.

4. The method of claim 1, wherein:
only the successful completion of the device readiness test triggers the performing of the media suitability test on the media file stored by the device; and
the initiating of the transcoding of the media file is based on both the successful completion of the device readiness test and the successful completion of the media suitability test.

5. The method of claim 1, wherein:
the media suitability test is configured to fail if the media file contemporaneously stored by the server machine and by the device is shared among multiple users; and
the media suitability test is configured to pass if the media file contemporaneously stored by the server machine and by the device is not shared among multiple users.

6. The method of claim 1, wherein:
the media suitability test includes calculating a breakeven time at which an upload cost of replacing the media file stored by the server machine with a transcoded version of the media file is superseded by a predicted discount resultant from the server machine storing the predicted file size of the media file instead of the current file size of the media file until at least the breakeven time.

7. The method of claim 6, wherein:
the media suitability test includes:
comparing the calculated breakeven time to a minimum breakeven time at which the upload cost of replacing the media file stored by the server machine with a transcoded version of the media file is superseded by the predicted discount resultant from the server machine storing the predicted file size of the media file instead of the current file size of the media file until at least the calculated breakeven time; and
determining that the calculated breakeven time fails to exceed the minimum breakeven time at which the upload cost of replacing the media file stored by the server machine with the transcoded version of the media file is superseded by the predicted discount resultant from the server machine storing the predicted file size of the media file instead of the current file size of the media file until at least the calculated breakeven time.

8. A non-transitory machine-readable storage medium comprising instructions that, when executed by one or more processors of a machine, cause the machine to perform operations comprising:
performing a device readiness test that checks readiness of a device for transcoding a media file stored by a server machine, the device readiness test including a storage check for contemporaneous storage of the media file by both the server machine and the device;
based on successful completion of the device readiness test, performing a media suitability test that checks the media file stored by the device, the media suitability test being based on comparison of a current file size of the media file stored by the server machine to a predicted file size of the media file if transcoded from a current compression level of the media file to a transcoded compression level of the media file; and
based on successful completion of the media suitability test, initiating a transcoding of the media file from the current compression level to the transcoded compression level by the device that stores the media file contemporaneously with the server machine.

9. The non-transitory machine-readable storage medium of claim 8, wherein:
the device readiness test includes a network check for network connectivity of the device to the server machine that contemporaneously stores the media file with the device.

10. The non-transitory machine-readable storage medium of claim 8, wherein:
the device readiness test includes a battery check for at least a minimum battery level at the device that stores the media file contemporaneously with the server machine.

11. The non-transitory machine-readable storage medium of claim 8, wherein:
only the successful completion of the device readiness test triggers the performing of the media suitability test on the media file stored by the device; and
the initiating of the transcoding of the media file is based on both the successful completion of the device readiness test and the successful completion of the media suitability test.

12. The non-transitory machine-readable storage medium of claim 8, wherein:
the media suitability test is configured to fail if the media file contemporaneously stored by the server machine and by the device is shared among multiple users; and
the media suitability test is configured to pass if the media file contemporaneously stored by the server machine and by the device is not shared among multiple users.

13. The non-transitory machine-readable storage medium of claim 8, wherein:
the media suitability test includes calculating a breakeven time at which an upload cost of replacing the media file stored by the server machine with a transcoded version of the media file is superseded by a predicted discount resultant from the server machine storing the predicted file size of the media file instead of the current file size of the media file until at least the breakeven time.

14. The non-transitory machine-readable storage medium of claim 13, wherein:
the media suitability test includes:
comparing the calculated breakeven time to a minimum breakeven time at which the upload cost of replacing the media file stored by the server machine with a transcoded version of the media file is superseded by the predicted discount resultant from the server machine storing the predicted file size of the media file instead of the current file size of the media file until at least the calculated breakeven time; and
determining that the calculated breakeven time fails to exceed the minimum breakeven time at which the upload cost of replacing the media file stored by the server machine with the transcoded version of the media file is superseded by the predicted discount resultant from the server machine storing the predicted file size of the media file instead of the current file size of the media file until at least the calculated breakeven time.

15. A system comprising:
one or more processors; and
a memory storing instructions that, when executed by at least one processor among the one or more processors, cause the system to perform operations comprising:
performing a device readiness test that checks readiness of a device for transcoding a media file stored by a server machine, the device readiness test including a storage check for contemporaneous storage of the media file by both the server machine and the device;
based on successful completion of the device readiness test, performing a media suitability test that checks the media file stored by the device, the media suitability test being based on comparison of a current file size of the media file stored by the server machine to a predicted file size of the media file if transcoded from a current compression level of the media file to a transcoded compression level of the media file; and
based on successful completion of the media suitability test, initiating a transcoding of the media file from the current compression level to the transcoded compression level by the device that stores the media file contemporaneously with the server machine.

16. The system of claim 15, wherein:
the device readiness test includes a network check for network connectivity of the device to the server machine that contemporaneously stores the media file with the device.

17. The system of claim 15, wherein:
the device readiness test includes a battery check for at least a minimum battery level at the device that stores the media file contemporaneously with the server machine.

18. The system of claim 15, wherein:
only the successful completion of the device readiness test triggers the performing of the media suitability test on the media file stored by the device; and
the initiating of the transcoding of the media file is based on both the successful completion of the device readiness test and the successful completion of the media suitability test.

19. The system of claim 15, wherein:
the media suitability test is configured to fail if the media file contemporaneously stored by the server machine and by the device is shared among multiple users; and
the media suitability test is configured to pass if the media file contemporaneously stored by the server machine and by the device is not shared among multiple users.

20. The system of claim 15, wherein:
the media suitability test includes calculating a breakeven time at which an upload cost of replacing the media file stored by the server machine with a transcoded version of the media file is superseded by a predicted discount resultant from the server machine storing the predicted file size of the media file instead of the current file size of the media file until at least the breakeven time.
